(19) United States
(12) Patent Application Publication
(10) Pub. No.: US 2003/0217574 A1
(43) Pub. Date: Nov. 27, 2003

(54) Lock device for a door and method of operating the lock device

(76) Inventor: Guido Meis, Koln (DE)

Correspondence Address: LERNER AND GREENBERG, P.A., Post Office Box 2480, Hollywood, FL, 33020-2480, US

(21) Appl. No.: 10/385,001

(22) Filed: Mar. 10, 2003

Related U.S. Application Data
(63) Continuation of application No. PCT/DE01/03386, filed on Sep. 5, 2001.

(30) Foreign Application Priority Data
Sep. 8, 2000 (DE) 100 44 723.6

(51) Int. Cl. E05B 49/00

(52) U.S. Cl. 70/257; 70/472; 70/278.7

(57) ABSTRACT

A locking device for a door containing at least one bolt for locking and unlocking the door, has a locking cylinder and at least one handle for opening the door. The bolt is coupled to the locking cylinder and the handle by a coupling. The handle is used to actuate the locking cylinder. An electronic control unit and at least one mobile identification carrier are interlinked by a wireless data transmission device, to verify the access authorization and to control the locking device. The locking device has circuit elements for this purpose. The circuit elements are connected to the control unit and the latter can be activated by the circuit elements when the handle is actuated.

### CROSS-REFERENCE TO RELATED APPLICATION

This application is a continuation of copending International Application No. PCT/DE01/03386, filed Sep. 5, 2001, which designated the United States and was not published in English.

### BACKGROUND OF THE INVENTION

### FIELD OF THE INVENTION

The invention relates to a lock device for keyless locking and unlocking of a door lock that has at least one bolt. The lock device has a lock cylinder that is operatively connected to the bolt, at least one handle for actuating the lock cylinder, and a cylinder casing that holds the lock cylinder. The lock device has an electronic control unit for checking an access authorization and for controlling the lock device as well as at least one mobile identity carrier that is assigned to device for the wire-free transmission of data to one another.

Lock devices of this type are used for locking and unlocking doors that are provided for equipping plug-in locks. Here, the lock cylinder and handle are preferably assigned in a force-locking fashion to the bolt. The lock cylinder preferably has a cylinder core with a closing web that is operatively connected to the bolt. The cylinder casing has a recess for holding the lock cylinder and a cylinder holder for attachment to the door.

The handle may be a rotary element, latch or pushbutton as well as other opening devices on doors that can be connected to the lock cylinder. The lock device is connected to an electronic control unit that is supplied with access data by a mobile identification carrier via the wire-free data transmission. If the data of the control unit corresponds to that which is subsequently received from the identification carrier, the lock device opens.

In particular in the case of internal doors in buildings, external doors in buildings and section doors in buildings and also doors of furniture such as cupboards and the like, lock devices of this type are used to ensure secure access control.

In conventional lock devices of this type, the identification carrier must be activated manually. It is a disadvantage of these lock devices that the identification carrier has to be manipulated for the lock device or the control unit to be activated. This handling is cumbersome and inconvenient.

On the other hand, it is achieved in that its control unit is permanently in a ready-to-operate state so that the interrogation and the checking of the access authorization is made possible. It is disadvantageous here that it must constantly transmit interrogations to the surroundings in order to possibly register identification carriers located in the vicinity and in order to interrogate the access data. These lock devices are costly to equip with a permanent power supply, which entails high costs for cabling and mounting and requires a considerable amount of space as it is inexpedient to operate the lock device with batteries owing to the high energy demand.

Published, Non-Prosecuted German Patent Application DE 197 38 938 A1 proposes in this context a lock that is provided with a bolt that can be activated electrically. In order to control the activation of the bolt, an electronic control unit is provided which has an external relay station. The control unit permanently transmits information on the operating state of the lock device to the relay station. On the other hand, from the relay station it receives information that includes instructions for opening and locking the lock device. The relay station is connected to a permanent power supply and receives, if appropriate, signals from approaching transponders that transmit access data to the lock device. The control unit is connected to a battery or energy feed line. It is disadvantageous with this lock device that, in order to maintain the operating function, a permanent exchange of data is necessary between the control unit and relay station and the relay station has to permanently search for approaching transponders. Moreover, the data transfer between the transponders and control unit always takes place via the relay station so that the operational capability of the entire lock device is put at risk if the relay station is functionally incapable, owing to a power failure for example.

European Patent EP 0 974 719, corresponding to U.S. Pat. No. 6,260,392, describes a lock for a lock system with a bolt activating device which disables a lock activation device via a lock element which is connected to an interrogation control or enables it, depending on whether or not a use authorization is present. Such a lock is located in a lock housing, such a device being disposed in each case in a lock compartment of the lock system. In order to activate the interrogation control, a switch that reacts to rotation and/or pressure of the rotary handle is provided in the rotary handle.

Here, the lock mechanism is implemented with a bolt activating device. The lock device does not have a lock cylinder or cylinder casing. A disadvantage of the lock mechanism is the large amount of space required. Furthermore, with such bolt locks the interior above the lock casing is subject to considerable contamination that can occur as a result of the opening of the bolt or may come about due to abrasion of the mechanical parts in the lock casing. As a result, the functional duration of the lock device is reduced, which makes more intensive maintenance necessary. Furthermore, the locking device of the lock compartment is not provided for use in plug-in locks.

Lock devices according to European Patent EP 0 974 719 also have the disadvantage that the switching device is disposed in the lock casing. The lock devices are costly to mount and operate and require considerable space outside the lock in order to accommodate the wiring, cabling and the necessary components.

In addition, in the lock devices previously described it is always necessary to take into account the later use with or without lock control during the actual manufacture of the doors or the preparation device for locks which are attached thereto, such as, for example, the lock insert, which entails cost disadvantages.

These disadvantages are avoided by the lock device according to German Patent DE 198 51 308 C2. This is a lock device that is used for locking and unlocking doors for which provision with plug-in locks is provided. Here, the lock cylinder and the handle are preferably assigned to the bolt in a force-locking fashion. The lock cylinder has a cylinder core with a closing web that is operatively connected to the bolt. The cylinder casing has a recess for holding the lock cylinder and a cylinder holder for attachment to the door.

The lock cylinder communicates with a transponder that activates an interrogation and checking operation for the access authorization by a signal that can be generated manually. In the process, the transponder and control unit exchange data, and when the check is positive the lock device is enabled for opening. The door can then be subsequently opened. It has proven disadvantageous that before the door is opened the identification carrier is manually operated or switched by the user by the transponder, and after the enabling process the door is to be opened manually by the lock device. This embodiment is inconvenient for the user.

### SUMMARY OF THE INVENTION

It is accordingly an object of the invention to provide a lock device for a door and a method of operating the lock device which overcome the above-mentioned disadvantages of the prior art devices and methods of this general type, which avoids the considerable space requirement of known lock devices and to make available a lock device which can be operated conveniently and which requires only a small degree of expenditure in terms of manual operation and maintenance.

With the foregoing and other objects in view there is provided, in accordance with the invention, a lock device for keyless locking and unlocking of a door lock having at least one bolt. The locking device contains a lock cylinder operatively connected to the bolt, at least one handle for actuating the lock cylinder, a cylinder casing holding the lock cylinder, an electronic control unit for checking an access authorization and for controlling the lock device, a device for wire-free transmission of data connected to the electronic control unit, at least one mobile identity carrier for interacting with the device for wire-free transmission of data, and a switching device connected to the electronic control unit. The electronic control unit is activated by the switching device upon activation of the handle. The switching device has a switch operatively connected to the lock cylinder, and the switch is integrated into the lock cylinder and/or the cylinder casing.

A solution of this object is made available by virtue of the fact that the lock device has a switching device. The switching device is connected to the control unit and the control unit is activated by the switching device when the handle is activated. The switching device contains a switch which is operatively connected to the lock cylinder and that the switch is integrated in the lock cylinder and/or in the cylinder casing.

The disadvantages of the prior art are advantageously avoided by the integrated configuration of the switching device proposed according to the invention. In particular, the operational reliability of the lock device is improved as the switching device that is integrated in the lock cylinder and/or cylinder casing is largely free of contamination and mechanical stresses. Furthermore, the lock device can easily be installed by virtue of the compact configuration so that it can be used as a replacement for old lock devices or plug-in locks in existing doors and for use in new door systems with lock preparation devices for conventional mechanical plug-in locks.

Furthermore, it is advantageously ensured that the interrogation by the control unit is activated automatically when the handle is activated. This initializes the checking of the access authorization. The activation of the control unit and the opening of the door thus take place largely in one step. This solution is a simple possible way of making the use of lockable doors reliable and convenient. As a result of the individual activation of the control unit, only little energy is required to activate the lock device so that costly cabling can be dispensed with.

The handle used here can be a rotatable latch or knob, a pushbutton or pulling device and touch-sensitive components such as pushbutton keys or the like. According to the invention, a magnet switch that has a magnet ring that can be activated by the handle is also provided. The switch is preferably connected here to the cylinder core that can be inserted into the lock cylinder. By activating the handle the cylinder core is moved, thus switching the switch so that the control unit is activated.

One advantageous development of the invention is obtained in that the switch is integrated on the outside of the door. On the outside of the door refers to in this context that the switch is disposed between the closing web and the outer termination of the lock cylinder or of the cylinder housing. The external termination is located here on the side of the external access region of the door.

The integrated configuration of the lock device according to the invention avoids the situation in which during the actual manufacture of the doors or the preparation device for locks that are attached thereto, it is necessary to take into account their later use with or without lock control. As a result, further savings are possible.

A preferred embodiment of the lock device according to the invention is achieved in that the switching device can be switched capacitively, inductively, magnetically or optically. Electronic components that act capacitively or inductively are advantageously provided as the switching device. Nevertheless, according to the invention it is possible to use mechanical or electronic switches as well as sensors such as, for example, movement sensors or proximity sensors.

A further refinement is provided if by virtue of the fact that the control unit has a transmitting and receiving device that contains at least one antenna, and the exchange of data with the identification carrier is carried out by of a radio-frequency electromagnetic alternating field. It is advantageous that the use of such an alternating field on the one hand permits small overall sizes of the transceiving unit and receiving unit that can easily be integrated into the corresponding components of the lock device, and on the other hand large ranges are possible for the transmission of data. It is thus no longer necessary to place the identification carrier in the direct vicinity of the lock device but rather it can remain conveniently with the user of the door so that the user no longer needs to manipulate the identification carrier.

According to the invention there is provision for the control unit to have a data processor circuit for processing data and having a microprocessor and a memory. The access data is stored in the memory, and for it to be possible to call the access data from the microprocessor for encryption for the transmission of radio data to the identification carrier and/or from the identification carrier for verification after reception of the response signal. As a result, a high degree of security is ensured as the lock device is prevented from being tampered with, thus preventing unauthorized access. Security is increased according to the invention by virtue of the fact that the transmitted signals for the transmission of radio data are encrypted, preferably cryptographically.

In order to open the door from the outside, it is necessary for a handle that is on the outside of the door to make access possible. Here, according to the invention there is provision for components of the control unit, preferably the transmitting and receiving device, to be integrated in the lock cylinder, in the cylinder casing and/or in the handle, preferably on the outside of the door. Here, the switching device is preferably disposed in the cylinder holder, and the antenna and the data processor are advantageously disposed in the lock cylinder, the cylinder casing or in the handle. The switching device or the device for the wire-free transmission of data are preferably integrated in the handle on the outside of the door. The components that relate to security are disposed on the inside of the door and are thus accessible from the outside. A good degree of data transmission is thus achieved by the transmitting and receiving device as neither the door material nor the lock device itself shields the antenna. It has proven particularly advantageous to integrate the antenna in the handle on the outside of the door or to configure the external handle as an antenna. The lock device in which the antenna is integrated in the cylinder casing that is fitted with the lock cylinder is also provided. The switching device can also be disposed the outside of the door, as a result of which the security is not restricted as the lock device cannot be opened by outside tampering with the switching means.

A further refinement of the lock device according to the invention is achieved by virtue of the fact that the control unit is integrated into the cylinder casing, preferably on the inside of the door. The control unit is advantageously disposed here in such a way that the data leads and power supply cables remain unmoved when the handle is activated, so that this is prevented from causing wear.

To enable the door to be opened according to the invention there is provision for the handle, the lock cylinder and/or the bolt to be coupled, preferably mechanically, by a coupling as long as the lock device is enabled for opening by the control unit, and for the handle to be otherwise decoupled from the lock cylinder and/or the bolt. With the coupling it is possible, by activating the handle, first to move the cylinder core and thus the closing web of the lock cylinder. If the control unit has established access authorization, the components are coupled. The lock device is thus opened by the coupling to the bolt. If the control unit has established that access is not authorized, that is to say there is no identification carrier present or the transmitted access data do not correspond to one another, the coupling remains in the uncoupled state and the handle cannot be activated, or the activation of the handle remains without effect. For example, a knob or a door latch will turn in a non-operative way if the coupling does not couple the components of the lock device.

One preferred refinement of the invention is achieved in that the lock device has an integrated power supply, preferably a battery or chargeable energy store. It is thus possible to operate the lock device independently of external power systems. Energy storage elements that can be charged in particular by photovoltaic cells or electromagnetically are provided as energy stores.

The invention provides a method for interrogating and verifying the access authorization, the control unit being activated by the switching device, the activated control unit transmitting an interrogation signal to the identification carrier, the identification carrier transmitting back a response signal, corresponding to the access data, to the control unit and the control unit checking the access data and enabling the lock device for opening when there is access authorization.

This is advantageously achieved in that the data transmission between the control unit and the identification carrier is carried by a radio-frequency electromagnetic alternating field and that the interrogation signals and response signals are encrypted by mathematical algorithms before transmission. For this purpose, there is also advantageously provision for the access data to be stored in the memory and to be encoded by the microprocessor for the transmission of radio data to the identification carrier, for the microprocessor to verify the response signal of the identification carrier after reception, and activate the coupling when there is access authorization. In this context, the handle is coupled to the lock cylinder and to the bolt.

Other features which are considered as characteristic for the invention are set forth in the appended claims.

Although the invention is illustrated and described herein as embodied in a lock device for a door and a method of operating the lock device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, cross-sectional view of a lock device with a handle and a magnetic switch according to the invention; and

FIG. 2 is a cross-sectional view of a cylinder casing of the lock device with control electronics that are integrated into the cylinder holder in an interior of a door.

### DESCRIPTION OF THE PREFERRED EMBODIMENTS

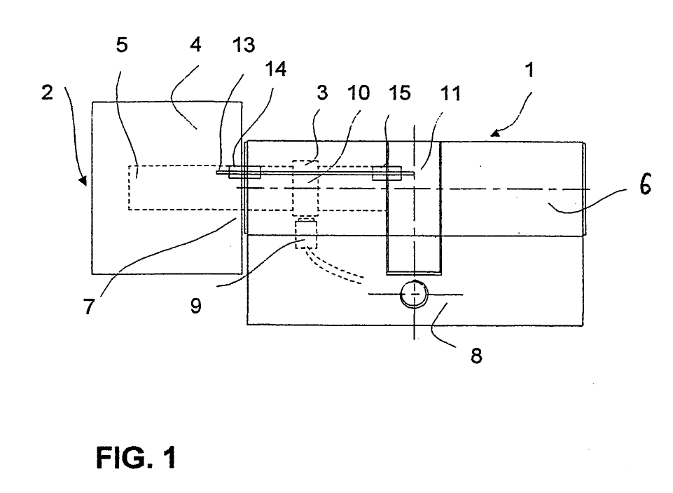

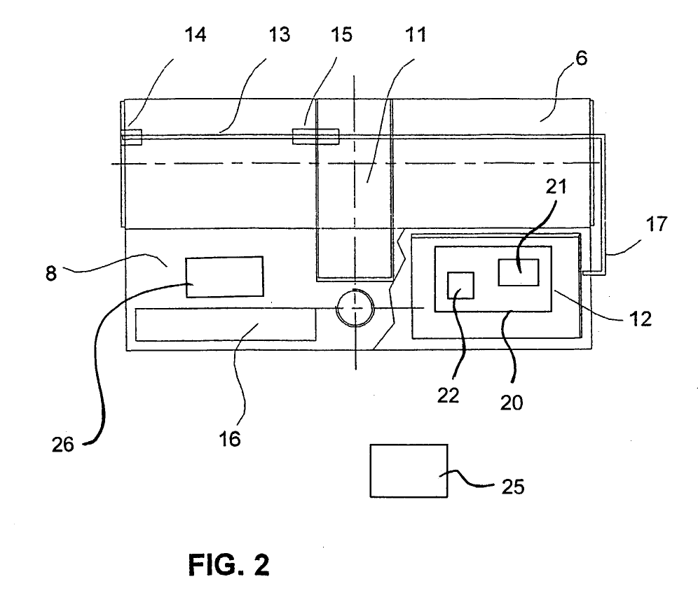

Referring now to the figures of the drawing in detail and first, particularly, to FIG. 1 thereof, there is shown a lock device 1 with a handle 2 and a switching device 3 shown in cross section. The handle 2 contains a knob 4 with a knob pin 5 that is connected to a cylinder core 6. The handle 2 is seated outside a door leaf on an end side 7 of the cylinder core 6. The cylinder core 6 is inserted into a cylinder casing 8 and is connected to the switching device 3. The switching device 3 contains a magnetic switch 9 with a magnetic ring 10 that turns with the cylinder core 6 and switches the magnetic switch 9 when the handle 2 is activated. As soon as the magnetic switch 9 switches, a control unit 12, which is connected electronically to the magnetic switch 9, is activated (FIG. 2). The integrated control unit 12 is illustrated in the cylinder casing 8 of the lock device 1. The control unit 12 is connected to the magnetic switch 9 and to a coupling 13. In the case of a positive check for access authorization by the control unit 12, the coupling 13 couples, by coupling elements 14, 15, the handle 2, the cylinder core 6 and a closing web 11 in order to activate a bolt of the door.

In order to unlock the lock device 1, first the handle 2 is activated. The handle 2 is assigned the magnetic switch 9 that generates a switching pulse that is transmitted to the control unit 12. The control unit 12 is activated by the switching pulse. The control unit 12 has a data processing unit 20 that contains a microprocessor 21 for encrypting an interrogation and access data and a storage device 22 for storing the access data.

After it has been activated, the control unit 12 transmits, via a transmitting and receiving device 16, an interrogation signal to an identification carrier 25 that in turn receives the interrogation signal via the transmitting and receiving device 16. The identification carrier 25 is activated by the interrogation signal and generates a response signal that is transmitted back to the control unit 12. The interrogation signal and the response signal are encoded according to the invention. There is provision for the identification carrier 25 to be equipped with a data processing unit that generates a response signal. Furthermore, a storage device for storing access data is provided. The invention also contains passive identification carriers that generate a response signal that is generated from the interrogation signal by an integrated circuit. The response signal, which corresponds to the access data, is transmitted back to the control unit 12 where it is compared with the access data that is stored there. If the access data corresponds to the response signal, access authorization is established and the lock device 1 is enabled for opening. The handle 2 is coupled to the lock cylinder 6 or the closing web 11 via the coupling 13 here so that when the handle 2 is activated further the lock device 1 opens readily. If no access authorization is established, the coupling 13 remains in the uncoupled state and the further activation of the handle 2 remains without effect. The lock device 1 does not open.

The transmission signals can be encoded by a simple code that is defined at the manufacturer, and the invention also provides for intelligent systems whose encoding is based on a randomly selected mathematical function or on random numbers. A high degree of operational reliability in the use of the lock device 1 can be achieved by cryptographic encryption. The encryption can, on the one hand, be performed directly by the control unit 12 using a data processing program. On the other hand, the encryption can also be performed by an electronic switching element that is additionally connected to the control unit 12, preferably capable of being plugged in from the outside, the switching element being preferably a chip card that has an integrated circuit for encryption. The lock device 1 according to the invention permits access through a door provided with it to be carried out easily. It is possible to dispense with an activation of the identification carrier here so that its presence within radio range is sufficient to be able to carry out the functions of the lock device 1. The functions of the lock device 1 are activated by merely activating (i.e. turning) the handle 2. The door is unlocked when there is access authorization. If there is no access authorization or if the control unit 12 is not activated, the door is locked.

FIG. 2 illustrates the cylinder casing 8 of the lock device with the integrated control unit 12. The closing web 11 is disposed on the cylinder core 6 and can be coupled to the handle 2 via the coupling 13. The control unit 12 is disposed in a region inside the door and has the transmitting and receiving device 16 which is disposed on the outside of the door. The closing web 11 represents the boundary between the inside and outside of the door. The cylinder core 6 can be coupled to the closing web 11 via the coupling 13 in that the coupling elements 14, 15 couple to one another and block the coupling 13 between the cylinder core 6 and the closing web 11. The coupling 13 is connected to the control unit 12 through data lines 17 so that the coupling 13 can be switched when the checking of the access authorization is positive.

The lock device has an integrated power supply 26, preferably a battery or chargeable energy store. It is thus possible to operate the lock device 1 independently of external power systems.

I claim:

1. A lock device for keyless locking and unlocking of a door lock having at least one bolt, the locking device comprising:
a lock cylinder operatively connected to the bolt;
at least one handle for actuating said lock cylinder;
a cylinder casing holding said lock cylinder;
an electronic control unit for checking an access authorization and for controlling the lock device;
a device for wire-free transmission of data connected to said electronic control unit;
at least one mobile identity carrier for interacting with said device for wire-free transmission of data; and
a switching device connected to said electronic control unit, said electronic control unit being activated by said switching device upon activation of said handle, said switching device having a switch operatively connected to said lock cylinder, and said switch integrated into at least one of said lock cylinder and said cylinder casing.

2. The lock device according to claim 1, wherein said switch is integrated on an outside of a door.

3. The lock device according to claim 1, wherein said switching device is switched capacitively, inductively, magnetically or optically.

4. The lock device according to claim 1, wherein said device for wire-free transmission of data is a transmitting and receiving device having at least one antenna and is integrated in said electronic control unit, and an exchange of data with said mobile identity carrier is carried out by a radio-frequency electromagnetic alternating field.

5. The lock device according to claim 1, wherein said electronic control unit has a data processing unit with a microprocessor and a memory, and access data is stored in said memory and can be called by said microprocessor for encryption for transmission of radio data to said mobile identity carrier and for verification after reception of a response signal.

6. The lock device according to claim 4, wherein said electronic control unit and said transmitting and receiving device are integrated in at least one of said lock cylinder, said cylinder casing and said handle.

7. The lock device according to claim 1, wherein said electronic control unit is integrated in said cylinder casing in an interior of a door.

8. The lock device according to claim 1, further comprising a coupling, said handle, said lock cylinder and the bolt are coupled by said coupling as long as the lock device is enabled for opening via said electronic control unit, said handle is otherwise decoupled from at least one of said lock cylinder and the bolt.

9. The lock device according to claim 1, further comprising an integrated power supply connected to said electronic control unit.

10. The lock device according to claim 9, wherein said integrated power supply is selected from the group consisting of a battery and a chargeable energy store.

11. The lock device according to claim 4, wherein said electronic control unit and said transmitting and receiving device are integrated in at least one of said lock cylinder, said cylinder casing and said handle on an outside of a door.

12. A method for verifying access authorization by a lock device, the lock device having a lock cylinder operatively connected to a bolt, at least one handle for actuating the lock cylinder, a cylinder casing holding the lock cylinder, an electronic control unit for checking the access authorization and for controlling the lock device, a device for wire-free transmission of data connected to the electronic control unit, at least one mobile identity carrier for interacting with the device for wire-free transmission of data, and a switching device connected to the electronic control unit, the electronic control unit being activated by the switching device upon activation of the handle, the switching device having a switch operatively connected to the lock cylinder, and the switch being integrated into at least one of the lock cylinder and the cylinder casing, which comprises the steps of:
activating the electronic control unit via the switching device;
transmitting an interrogation signal to the mobile identity carrier through the electronic control unit, carrying out the transmitting using a radio-frequency electromagnetic alternating field, and the interrogation signal being encrypted by mathematical algorithms before a transmission;
using the mobile identity carrier for transmitting back a response signal, corresponding to access data, to the electronic control unit, carrying out the transmitting using a radio-frequency electromagnetic alternating field, and the response signal being encrypted by mathematical algorithms before a transmission; and
checking, in the electronic control unit, the access data and enabling the lock device for opening if the access authorization exists.

13. The method according to claim 12, which comprises the steps of:
storing the access data in a memory; and
using a microprocessor for encoding the access data to be transmitted as radio data to the mobile identity carrier, the microprocessor verifying the response signal from the mobile identity carrier after receiving the response signal and activates a coupling if proper access authorization exists.
